(19) United States
(12) Patent Application Publication
(10) Pub. No.: US 2026/0080243 A1
(43) Pub. Date: Mar. 19, 2026

(54) ADAPTIVE FLOW MATCHING FOR RESOLVING SMALL-SCALE PHYSICS

(71) Applicant: NVIDIA Corporation, Santa Clara, CA (US)

(72) Inventors: Efstathios Fotiadis, San Jose, CA (US); Morteza Mardani Korani, San Jose, CA (US); Tomas Geffner, Santa Clara, CA (US); Noah Brenowitz, Seattle, WA (US); Yair Cohen, Hollywood, FL (US); Arash Vahdat, San Mateo, CA (US); Mike Pritchard, Encinitas, CA (US)

(21) Appl. No.: 19/180,698

(22) Filed: Apr. 16, 2025

Related U.S. Application Data
(60) Provisional application No. 63/694,414, filed on Sep. 13, 2024.

(51) Int. Cl. G06N 3/08; G01W 1/00; G06N 3/045

(52) U.S. Cl. CPC G06N 3/08; G01W 1/00; G06N 3/045

(57) ABSTRACT

Apparatuses, systems, and techniques for adaptive flow matching. In at least one embodiment, input is received, which includes one or more first variables at first scale. An encoder is used to encode the input to provide a base distribution at the first scale. The base distribution is associated with one or more second variables, and the one or more second variables include one or more variables absent from the one or more first variables. A perturbed base distribution is obtained based on the base distribution and an adaptive noise. A diffusion model is used to generate a target distribution at a second scale. The target distribution is associated with the one or more second variables. The second scale is finer than the first scale.

### CLAIM OF PRIORITY

This application claims the benefit of U.S. Provisional Application No. 63/694,414 titled “Stochastic Flow Matching For Resolving Small-Scale Physics,” filed Sep. 13, 2024, the entire contents of which are incorporated herein by reference.

### BACKGROUND

Resolving small-scale physics is crucial in many scientific applications. For instance, in the atmospheric sciences, accurately capturing small-scale dynamics is essential for local planning and disaster mitigation. Conditional diffusion models, which have been demonstrated to be successful in super-resolving natural images and videos, have recently been extended to super-resolving small-scale physics. However, this task faces significant challenges.

### BRIEF DESCRIPTION OF THE DRAWINGS

The present systems and methods for adaptive flow matching for resolving small-scale physics are described in detail below with reference to the attached drawing figures, wherein:

FIG. 1A illustrates a flowchart of a method for adaptive flow matching, in accordance with certain embodiments.

FIGS. 1B and 1C illustrate examples of input variables and target variables, respectively, in accordance with certain embodiments.

FIGS. 1D and 1E illustrate examples of obtaining sigma values for various target variables, in accordance with certain embodiments.

FIG. 2A is a schematic illustrating a framework for adaptive flow matching, in accordance with certain embodiments.

FIG. 2B illustrates a flow matching process, in accordance with an embodiment.

FIG. 3A is a flow diagram illustrating a method for training a framework for adaptive flow matching, in accordance with certain embodiments.

FIG. 3B illustrates a comparison of model performance, in accordance with certain embodiments.

FIG. 3C illustrates examples of outputs from various models, in accordance with certain embodiments.

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Systems and methods are disclosed herein that relate to adaptive flow matching for resolving small-scale physics. In at least one embodiment, systems and methods are disclosed herein that provide an integrated approach that combines generative flow matching with encoding for conditional generation. This approach addresses the challenges of misalignment between input and output distributions, of multi-scale dynamics at different resolutions (e.g., deterministic dynamics at large scales and stochastic dynamics at small scales), and of overfitting (e.g., in data-limited regimes).

In at least one embodiment, a framework, which includes an encoder and an adaptive flow matching (AFM) network, is configured to receive coarse-resolution input data and produce fine-resolution output data. An adaptive noise schedule is designed to parameterize an impact of the encoding process performed by the encoder. In at least one embodiment, an adaptive noise schedule, which parameterizes encoding noise for various channels (corresponding to different target variables), is obtained through training. In at least one embodiment, the adaptive noise schedule is designed based on the maximum likelihood criterion, which balances the learning of deterministic and stochastic components between the encoder and flow matching. In at least one embodiment, the framework is utilized to match spatially misaligned data (and/or misaligned channels) with multiscale physics, specifically tailored for data-limited regimes in physical sciences.

The framework disclosed herein spans several applications in physical sciences where the input and output are solutions to different partial differential equations (PDEs) governed by different physics. In at least one embodiment, the input is a coarse resolution input representing large-sale physics, while the output is a fine resolution output representing small-scale physics. For example, the framework is capable of resolving the small-scale structures in atmospheric data by bridging the spectral differences between coarse-resolution inputs and fine-resolution outputs. The framework ensures a more realistic and accurate generation of small-scale physics, e.g., in atmospheric sciences for phenomena like wind, temperature, and radar reflectivity across different scales. Experiments on synthetic and real-world datasets have demonstrated that the framework disclosed herein outperforms existing methods, particularly when input and target distributions are significantly misaligned.

By integrating the encoder with the flow-matching network and utilizing an adaptive noise schedule that parameterizes the impact of the encoding process, the framework provides an end-to-end solution that significantly alleviates data overfitting issues present in prior approaches. By balancing deterministic and stochastic errors and applying adaptive noise scaling per channel, the framework consistently performs well across varying levels of data misalignment, showcasing its robustness. Additionally, the framework maintains strong fidelity across different levels of misalignment, effectively preserving both small- and large-scale structures under various misalignment conditions.

A method is provided for adaptive flow matching, which includes: receiving input comprising one or more first variables at a first scale, and encoding, using an encoder, the input to provide a base distribution at the first scale. In at least one embodiment, the base distribution is associated with one or more second variables, and the one or more second variables include one or more variables absent from the one or more first variables. The method further includes: obtaining, based on the base distribution and an adaptive noise, a perturbed base distribution, and generating, by a diffusion model, a target distribution at a second scale. In at least one embodiment, the target distribution is associated with the one or more second variables, and the second scale is finer than the first scale.

According to an embodiment of the method, the adaptive noise is determined based on a noise parameter. In at least one embodiment, the noise parameter is determined based on evaluating errors from the encoding process.

According to an embodiment of the method, the noise parameter is dynamically updated by calculating a root-mean-square-error (RMSE) of a residual error, the residual error is determined based on a difference between the output from the encoder and the output from the diffusion model.

According to an embodiment of the method, the noise parameter is a vector comprising one or more elements. In at least one embodiment, each of the one or more elements in the noise parameter corresponds to a second variable among the one or more second variables.

According to an embodiment of the method, the encoder and the diffusion model are trained jointly.

According to an embodiment of the method, the base distribution and the target distribution are processed in latent space.

According to an embodiment of the method, the diffusion model receives the perturbed base distribution as an initial input. In at least one embodiment, the diffusion model generates features at the second scale over multiple iterations.

According to an embodiment of the method, the diffusion model comprises a denoising network. The method further includes: receiving, by the denoising network at each iteration, output from the previous iteration as input to obtain a velocity field, and generating, by the denoising network, the output for the respective iteration by adding an amount of features based on the velocity field.

According to an embodiment of the method, the input and output include weather data, and the one or more first variables and the one or more second variables include weather variables.

A machine-readable medium is provided having stored thereon a set of instructions, which if performed by one or more processors, cause the one or more processors to perform the method for adaptive flow matching.

A system is provided for adaptive flow matching, which includes one or more processors to receive input comprising one or more first variables at a first scale, and encode, using an encoder, the input to provide a base distribution at the first scale. In at least one embodiment, the base distribution is associated with one or more second variables, and the one or more second variables includes one or more variables absent from the one or more first variables. The one or more processors further perform: obtaining, based on the base distribution and an adaptive noise, a perturbed base distribution, and generating, by a diffusion model, a target distribution at a second scale. In at least one embodiment, the target distribution is associated with the one or more second variables, and the second scale is finer than the first scale.

According to an embodiment of the system, the adaptive noise is determined based on a noise parameter. In at least one embodiment, the noise parameter is determined based on evaluating errors from the encoding process.

According to an embodiment of the system, the noise parameter is dynamically updated by calculating a root-mean-square-error (RMSE) of a residual error, the residual error is determined based on a difference between the output from the encoder and the output from the diffusion model.

According to an embodiment of the system, the noise parameter is a vector comprising one or more elements. In at least one embodiment, each of the one or more elements in the noise parameter corresponds to a second variable among the one or more second variables.

According to an embodiment of the system, the encoder and the diffusion model are trained jointly.

According to an embodiment of the system, the base distribution and the target distribution are processed in latent space.

According to an embodiment of the system, the diffusion model receives the perturbed base distribution as an initial input. In at least one embodiment, the diffusion model generates features at the second scale over multiple iterations.

According to an embodiment of the system, the diffusion model comprises a denoising network. The one or more processors further perform: receiving, by the denoising network at each iteration, output from the previous iteration as input to obtain a velocity field, and generating, by the denoising network, the output for the respective iteration by adding an amount of features based on the velocity field.

According to an embodiment of the system, the input and output include weather data, and the one or more first variables and the one or more second variables include weather variables.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

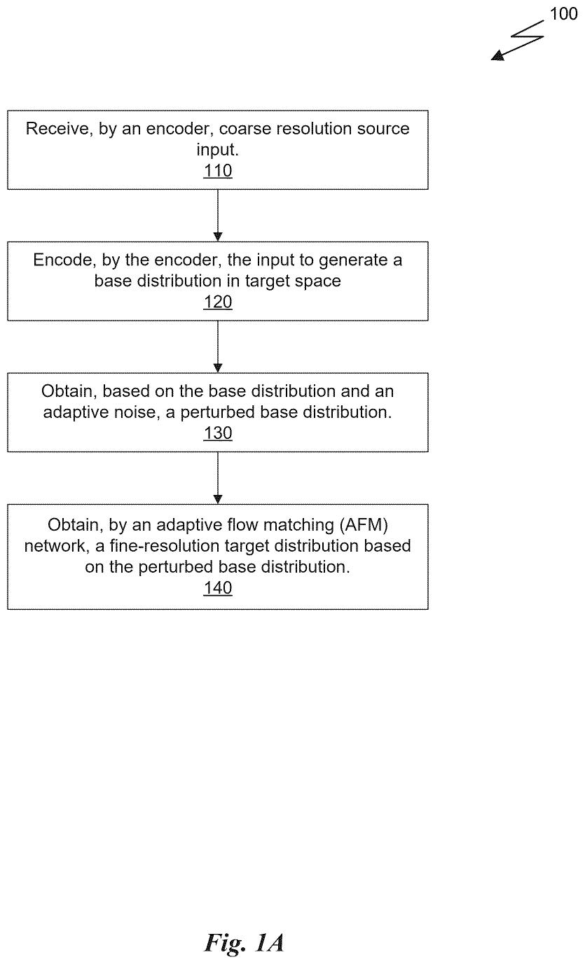

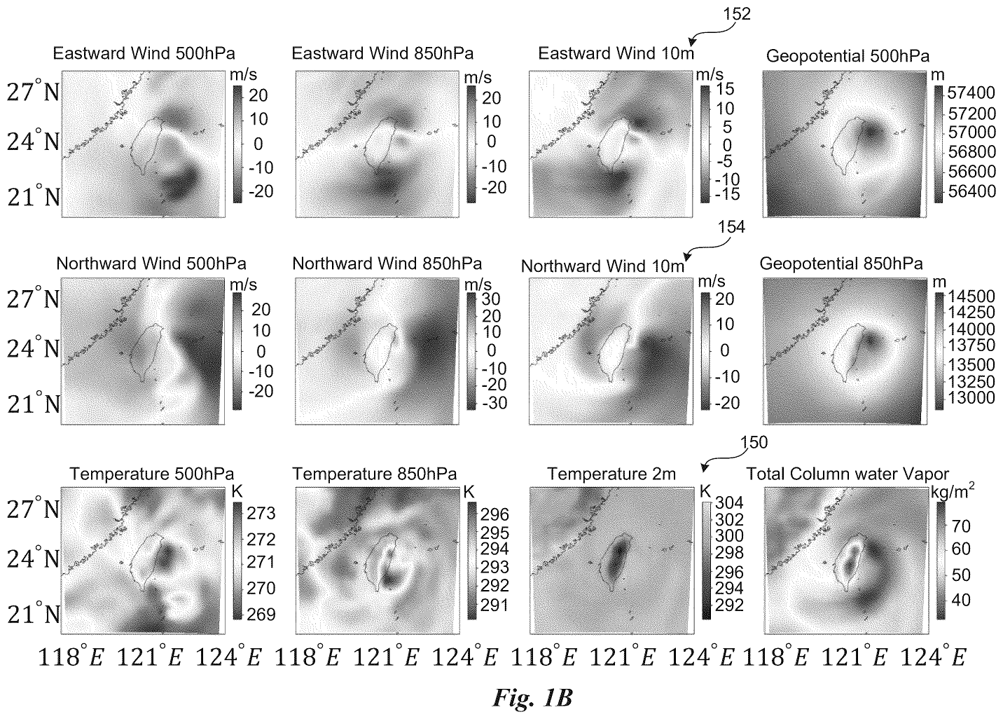

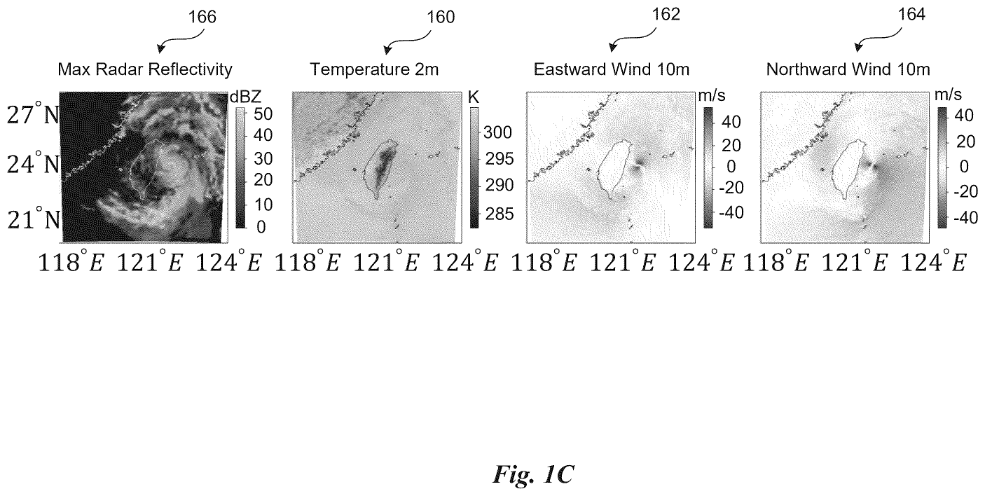

FIG. 1A is a flow diagram illustrating a method 100 for adaptive flow matching, in accordance with an embodiment. Each block of method 100, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. The method 100 may be executed by any one system, or any combination of systems, including, but not limited to, those described herein. Furthermore, persons of ordinary skill in the art will understand that any system that performs method 100 is within the scope and spirit of embodiments of the present disclosure.

The method 100 utilizes an encoder and an adaptive flow matching (AFM) network to process coarse-resolution source input and provide fine-resolution target output. Method 100 can be applied to various physical sciences related applications. To illustrate an example, method 100 is demonstrated with reference to a weather forecasting process. In at least one embodiment, method 100 is performed to provide a weather forecast at a two-kilometer (2 km) scale in the target space, based on raw atmospheric data at a twenty-five-kilometer (25 km) scale in the input space. For example, the method 100 first predicts a base distribution at the 25 km scale in the target space using the encoder and then predicts a target distribution at the 2 km scale in the target space using the AFM network.

At stage 110, the encoder receives the coarse-resolution source input. The coarse-resolution source input includes a first set of channels (i.e., variables) that make up an input space, while the fine-resolution target output includes a second set of channels (i.e., variables) that make up a target space. In certain embodiments, the input space and target space are represented by different sets of parameters/variables. For example, in the context of weather forecasting, the input space may correspond to various atmospheric variables, e.g., temperature, atmospheric pressure, wind conditions, radar reflectivity, and others—each with distinct statistical properties. The target space may correspond to alternative variables, e.g., precipitation, humidity, cloud cover, or other derived meteorological metrics. In at least one embodiment, the target space includes one or more variables from the input space.

FIGS. 1B and 1C illustrate examples of input variables and target variables, respectively, in accordance with certain embodiments. As shown in FIG. 1B, input variables represent various weather data, such as temperature and wind conditions. FIG. 1C shows that target variables also represent various weather data. In the illustrated examples, the target variables include “Temperature 2m” data 160, “Eastward Wind 10m” data 162, and “Northward Wind 10m” data 164, which correspond to the input variables “Temperature 2m” data 150, “Eastward Wind 10m” data 152, and “Northward Wind 10m” data 154 in the input space. The terms “10m” and “2m” refer to the heights above the ground at which the corresponding meteorological variables are measured. Compared to the input variables, the target variables in the target space exhibit a higher resolution. Additionally, the maximum radar reflectivity data 166 (i.e., “Max Radar Reflectivity”) is a target variable that is absent from the input space. The maximum radar reflectivity can be constructed by the executing the method 100 using one or more input variables from the input space. The method 100 can address misalignment between coarse- and fine-resolution data, as well as between the input and output spaces, which include different sets of channels (or variables).

At stage 120, the encoder encodes the input to generate a base distribution in the target space. The base distribution corresponds to coarse-resolution (or large-scale) data. The encoder is configured to encode the coarse-resolution source input and thereby provide the base distribution in the target space. In at least one embodiment, the base distribution is a latent base distribution predicted based on deterministic dynamics.

The encoding matches the large-scale, primarily deterministic dynamics of the input and output, aligning spatially misaligned large structures due to diverging trajectories. For example, in atmospheric sciences, the spatial misalignment arises because the input is the weather forecast at a 25 km scale, while the output is the forecast at a 1 km scale. Furthermore, the encoding aligns the first and second sets of channels by projecting the coarse-resolution source input into the target space, where the input space and the target space may include different weather variables.

In at least one embodiment, the encoder transforms coarse-resolution inputs into a latent distribution more aligned with the fine-resolution (or high-resolution) target. In at least one embodiment, the encoder generates channels absent in the input and corrects both spatial and channel misalignments, such as repositioning a typhoon's eye to a more accurate location, and generating radar data that is not provided in the input (e.g., as demonstrated in FIGS. 1B and 1C).

In at least one embodiment, the encoding process is formulated as: zₒ=€ (y), where y represents the coarse resolution source input, E represents the encoding operation performed by the encoder, and z (or zₒ) represents one or more latent variables corresponding to the base distribution in the target space. In at least one embodiment, the target output is represented as x, which includes the same variables as z but at a finer resolution.

In certain embodiments, y represents a set of weather variables, corresponding to the first set of channels in the input space, while z and x represent a different set of weather variables, corresponding to the second set of channels in the target space.

At stage 130, a perturbed base distribution is obtained based on the base distribution and an adaptive noise. For example, the base distribution is injected with the adaptive noise. In at least one embodiment, the adaptive noise is added to the one or more latent variables zₒ to provide one or more perturbed latent variables (z), formulated as:

$$z = ℰ ( y ) + {σ}_{z} ϵ , ϵ \sim ( 0 , I ) , \qquad ( Eq . 1 )$$

where σ_{z} represents a noise parameter, and e represents Gaussian noise. The noise parameter (σ_{z}) controls the scale of the noise added to the encoder's output ε(y). This noise perturbation (σ_{z}∈) accounts for uncertainty in the encoding phase in stage 120. For example, the noise parameter (o_{z}) represents the noise introduced by the encoder.

At stage 140, the AFM network obtains a target distribution in the target space based on the perturbed base distribution. The target distribution corresponds to fine-resolution (or small-scale) data. The AFM network performs flow matching to transform the perturbed base distribution into the target distribution. In at least one embodiment, output in pixel space, such as weather map, can be obtained based on the target distribution obtained in stage 140.

In certain embodiments, the perturbed base distribution (or base distribution) and the target distribution are represented by p(z) and p(x), respectively. From the latent space, the flowing matching process generates small-scale physics by transporting samples from p(z) to p(x) via a velocity field (v(x,t)). In at least one embodiment, the AFM network is a diffusion model that includes a denoising neural network ( [symbol] ) and the velocity field (v(x,t)) is obtained using the denoising neural network ( [symbol] ). In certain embodiments, the AFM network includes a 1× 1 convolution network or a U-Net network.

In at least one embodiment, the AFM network performs flow matching on the second set of channels in the target space through a number of iterations to obtain the target output (x). Each channel (e.g., of the first and second sets of channels) can be associated with different stochasticity characteristics.

The adaptive noise schedule enables control of the stochasticity in the flow matching performed by the AFM network via the noise (e.g., parameterized by σ_{z}) injected at the encoder output. In at least one embodiment, the noise parameter (σ_{z}) is a vector, which represents the adaptive noise scaling per channel for the second set of channels in the target space. The noise parameter (σ_{z}) can be dynamically tuned by monitoring the performance of the encoder and the AFM network during the execution of the method 100. For example, the noise parameter (σ_{z}) can be defined as a root-mean-square-error (RMSE) of the unnormalized residual error (x−ε(y)), as:

$${σ}_{z} = \sqrt{𝔼 [ {‖ x - ℰ ( y ) ‖}^{2} ]} . \qquad ( Eq . 2 )$$

In at least one embodiment, the encoder's RMSE can be calculated using a validation set every 10k (or other number of) training steps, thereby allowing the noise parameter (o_{z}) to be dynamically updated based on these measurements (e.g., based on the validation sets) as training progresses. Intuitively, if the encoder (which may be a deterministic regression model) overfits to a small training dataset, the validation RMSE will grow and thus, the overall model (including the encoder and the AFM network) will adaptively use a higher noise scale (e.g., the noise parameter σ_{z}) in the output of the encoder. At iteration k, an exponential moving average (EMA) can be used to adaptively select σ_{z}(k), ensuring that the noise scale is continuously updated to reflect the overall model's performance over time. For example, the adaptive noise scale (e.g., the noise parameter (σ_{z})) at iteration k is defined as: σ_{z}←(1−β)σ_{z}+βσ_{z}(k), where β can be tuned to adjust the “speed” at which the average responds to new data.

To evaluate the behavior of the adaptive noise scaling mechanism in the overall model, the sigma values (in the σ_{z} vector) across different channels are monitored during the training process for the model with a penalty weight λ=0.25. In at least one embodiment, the sigma values are initially set to 1 for all channels.

FIGS. 1D and 1E illustrate examples of obtaining sigma values for various target variables, in accordance with certain embodiments. In FIG. 1D, the encoder utilizes a 1×1 convolution network, while in FIG. 1E, the encoder utilizes a U-Net network. The target variables include variables representing radar reflectivity, temperature, castward wind, and northward wind, for example, as shown in FIG. 1C. As training progresses and the encoder's performance improves, the sigma values begin to stabilize and converge towards their final values, for examples, as depicted by curves 172-178 in FIG. 1D and curves 182-188 in FIG. 1E. In at least one embodiment, the sigma values in the σ_{z} vector can correspond to various channels and exhibit different values.

Additionally, with 1× 1 convolution network, σ_{z} increases during early training due to high encoder error and subsequently converges as the encoder improves. With U-Net network, σ_{z} starts decreasing with training. In both cases, the radar reflectivity channel (curve 172 or 182) exhibits the highest sigma values throughout the training process, reflecting its inherently stochastic nature. This is consistent with the understanding that radar data contains significant variability and uncertainty. In contrast, the temperature channel (curve 174 or 184) consistently shows the lowest sigma values, aligning with its more deterministic characteristics. The variations in sigma (o_{z}) across channels underscore the effectiveness of the adaptive noise scaling approach, as this approach allows the overall model to appropriately adjust noise levels based on the inherent uncertainty of each channel. This adaptability facilitates the management of misaligned data with differing degrees of stochasticity, thereby enhancing the overall performance and reliability of the overall model in multiscale physics applications.

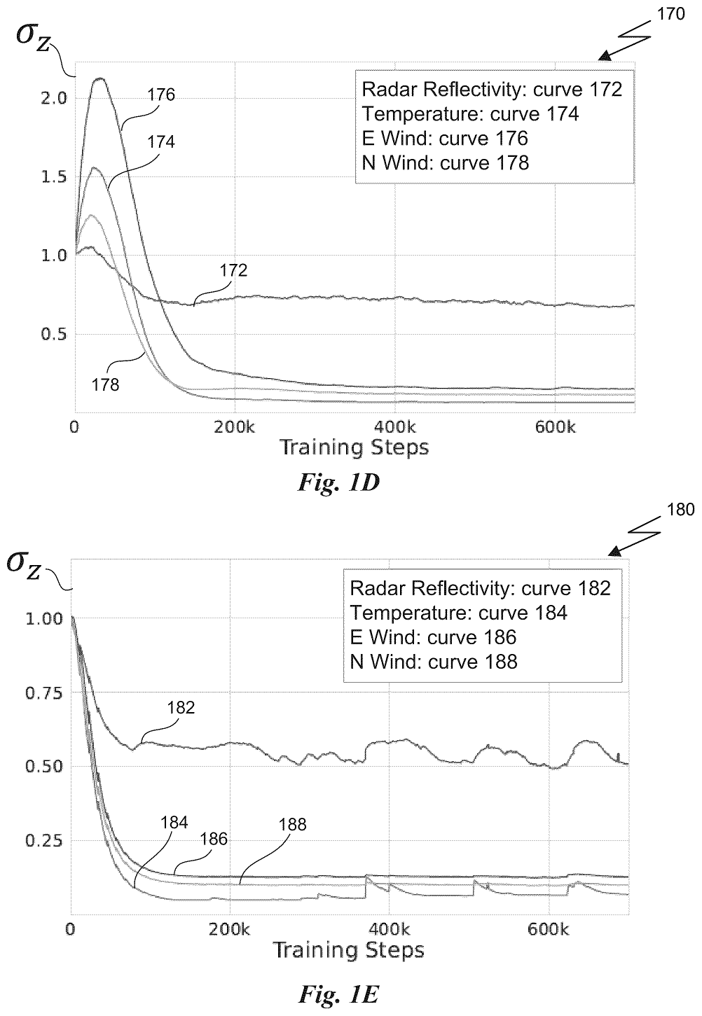

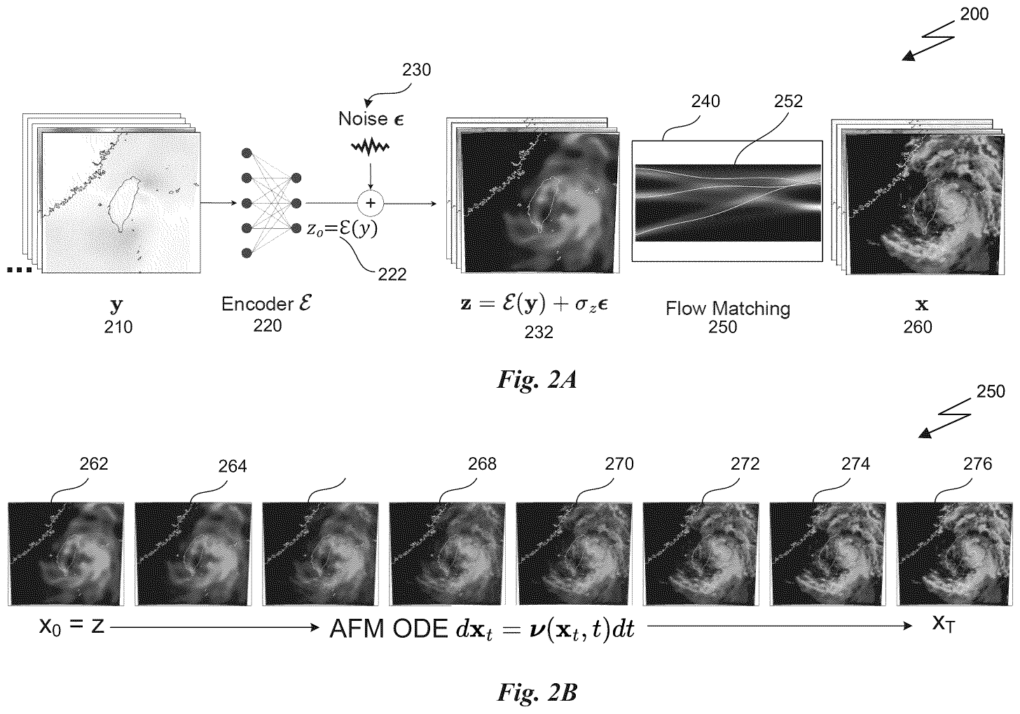

FIG. 2A is a schematic illustrating a framework 200 for adaptive flow matching, in accordance with certain embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the framework 200 is within the scope and spirit of embodiments of the present disclosure.

As shown in FIG. 2A, the framework 200 includes an encoder 220 (denoted by E) and an AFM network 240.

The encoder 220 receives input data (y) 210 in an input space. The input data includes one or more channels (or variables), forming a first set of channels. In at least one embodiment, the encoder 220 performs stage 110 of method 100 to receive the input data 210 and performs stage 120 of method 100 to generate a base distribution in the target space. The target space corresponds to a second set of channels. In at least one embodiment, the encoder 220 outputs one or more latent variables (zₒ=ε(y)) 222 corresponding to the second set of channels.

The framework 200 obtains a perturbed base distribution based on the input. In at least one embodiment, the framework 200 performs stage 130 of method 100 to add an adaptive noise (∈) 230 to the one or more latent variables (zₒ) 222. As a result, the framework 200 obtains one or more noisy latent variables (z) 232, corresponding to the perturbed base distribution (p(z)). As expressed in Equation 1, the one or more noisy latent variables (z) 232 can be expressed as: z=ε(y)+σ_{z}∈.

The AFM network 240 processes the one or more noisy latent variables (z) 232 to obtain output (x) 260 in the target space. In at least one embodiment, the AFM network 240 performs stage 140 of method 100 to obtain a target distribution (p(x)) in the target space based on the perturbed base distribution (p(z)). In at least one embodiment, the framework 200 generates one or more weather maps corresponding to the second set of channels based on the target distribution (p(x)) corresponding to the output (x) 260.

The AFM network 240 performs flow matching 250 to obtain the output (x) 260. FIG. 2B illustrates the flow matching 250, in accordance with an embodiment. In FIG. 2B, “AFM” stands for adaptive flow matching, and “ODE” stands for Ordinary Differential Equation. In at least one embodiment, the flow matching 250 includes a denoising process that involves a number of iterations. For example, the denoising process is initiated as x₀=z. The AFM network 240 iteratively denoises the input data from the previous iteration (or the initial input). For example, at each iteration, the AFM network 240 may remove an amount of noise (dxₜ), expressed by:

$${dx}_{t} = v ( {x}_{t} , t ) dt , \qquad ( Eq . 3 )$$

where v(x,t) represents a velocity field. A series of weather maps 262-276 illustrates an example effect of the iterative denoising process, starting with the initial weather map 262, adding small-scale details at each iteration, and ultimately producing a final weather map 276 with fine resolution.

In at least one embodiments, the flow matching 250 is a generative process that can be modeled as a solution to differential equations corresponding to the one or more target variables (e.g., the one or more second channels) in the target space. The target variables may exhibit varying solution trajectories, for example, represented as diverging curves in plot 252.

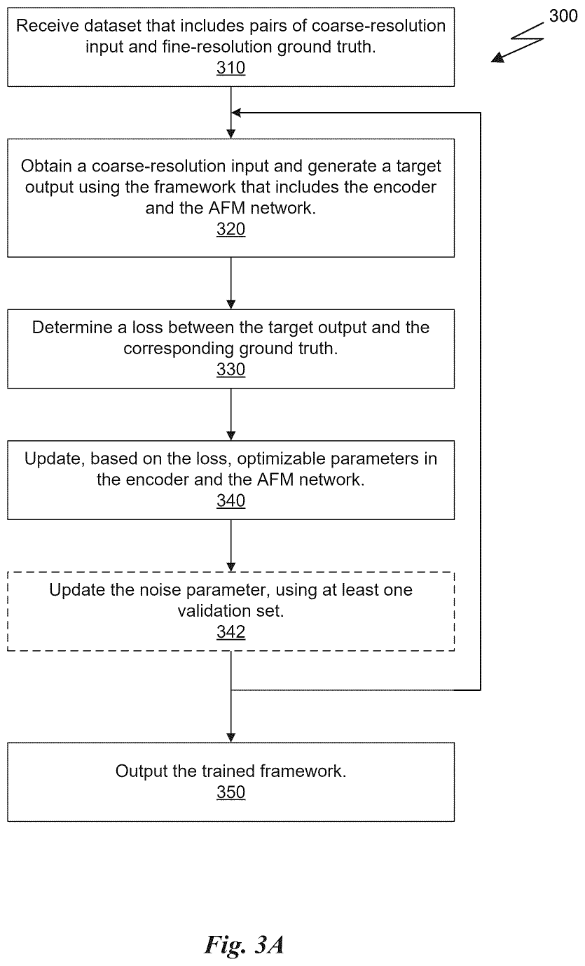

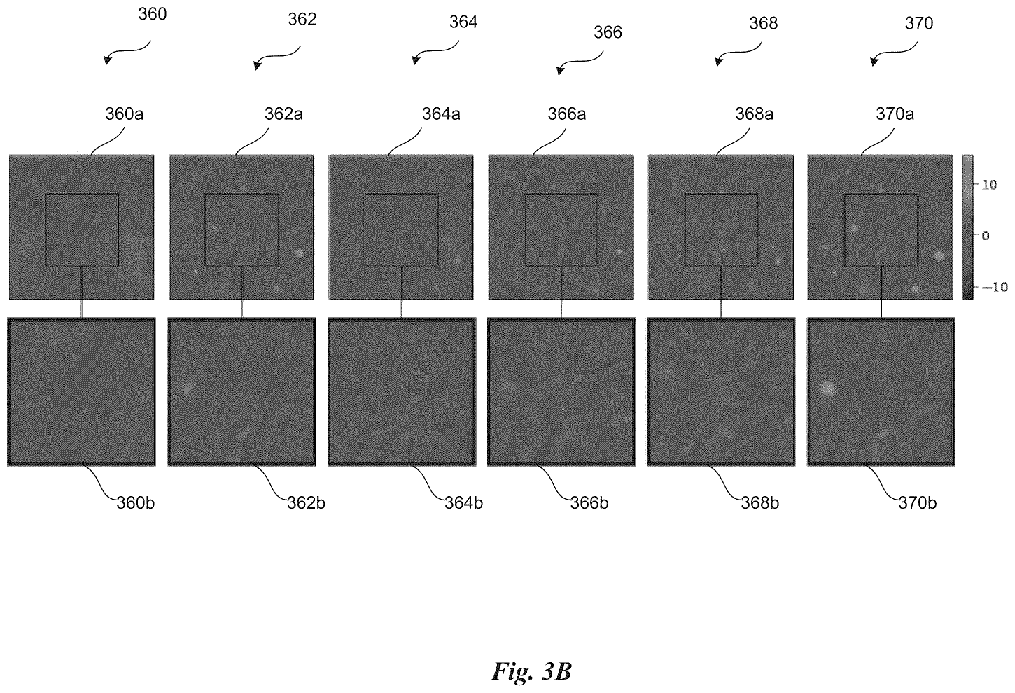

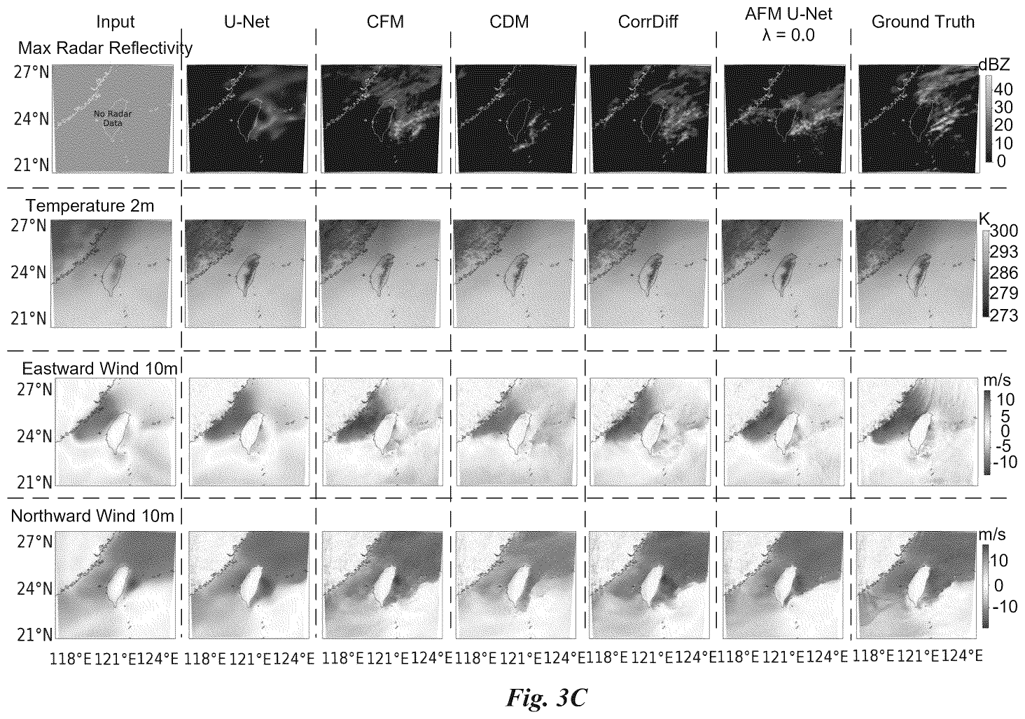

FIG. 3A is a flow diagram illustrating a method 300 for training a framework for adaptive flow matching, in accordance with certain embodiments. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. The method 300 may be executed by any one system, or any combination of systems, including, but not limited to, those described herein. Furthermore, persons of ordinary skill in the art will understand that any system that performs method 300 is within the scope and spirit of embodiments of the present disclosure.

In at least one embodiment, the framework 200 is trained by executing the method 300. For example, the method 300 utilizes an end-to-end training scheme to train the encoder 220 and the AFM network 240 jointly. However, it should be noted that other suitable adaptive frameworks for adaptive flow matching can be trained by executing the method 300, and the resulting frameworks can achieve similar functions as disclosed herein.

In at least one embodiment, the noise parameter (o_{z}) can be obtained through the training process. In at least one embodiment, the framework 200 is initiated before starting the training process. For example, the sigma values in a noise parameter vector (o_{z}) are initially set to 1 for all channels.

At stage 310, the framework 200 receives training dataset that includes pairs of coarse-resolution input and fine-resolution ground truth (as ground truth target output).

At stage 320, the framework 200 obtains a coarse-resolution input and utilizes the encoder (ε) 220 and the AFM network 240 to generate a target output based on the coarse-resolution input.

At stage 330, the framework 200 determines a loss between the target output from stage 320 and the ground truth target output from stage 310.

At stage 340, the framework 200 updates optimizable parameters in the encoder (ε) 220 and the AFM network 240 based on the loss determined in stage 330. For example, a gradient may be calculated based on the loss and utilized to update the optimizable parameters in the framework.

In at least one embodiment, the AFM network 240 utilizes a denoising neural network ( [symbol] ). The optimizable parameters include learnable weights in the encoder (ε) and learnable weights (θ) in the denoising neural network ( [symbol] ). The pairs of coarse-resolution input and fine-resolution ground truth are denoted as

$${\{ ( {y}_{i} , {x}_{i} ) \}}_{i = 1}^{N} .$$

In at least one embodiment, the penalty weight (λ) is incorporated to apply a soft regularization (as an encoder regularization), encouraging the output of the encoder to approximate the target, thus minimizing a residual error (e). The residual error (e) represents the difference between the target x and the encoder output ε(y), expressed as:

$$e = x - ℰ ( y ) . \qquad ( Eq . 4 )$$

In at least one embodiment, the residual error (e) is controlled through encoder regularization. For example, a regression-based regularization term can be imposed on the encoder, encouraging the output of the encoder to approximate the target, i.e., x≈ε(y), thus minimizing the residual error (e). To mitigate overfitting while maintaining generalization capability, soft regularization can be applied, controlled by the penalty weight λ. This weight (A) balances the trade-off between reducing the residual error and maintaining the generalization ability of the model. The resulting objective function becomes:

$${min}_{ℰ , θ} {𝔼}_{x , y , {σ}_{t}} \sim 𝒰 [ 0 , {σ}_{z} ] [ {( \frac{{σ}_{z}}{{σ}_{t}} )}^{2} {‖ {𝒟}_{θ} ( {x}_{t} , {σ}_{t} ) - x ‖}^{2} + λ {‖ e ‖}^{2} ] . \qquad ( Eq . 5 )$$

The encoder (ε) and denoiser ( [symbol] ) are trained jointly to minimize the denoising and regression losses.

The residual error (e) conveys the essential information about the input conditioning y required for generating the target x. In at least one embodiment, the residual error (e) at time t is defined as: eₜ=xₜ−ε(y). This results in a form that closely resembles a standard flow matching forward process, with Gaussian noise as the base distribution. The standard flow matching forward process can be expressed as: eₜ=te+(1−t)∈, t∈[0,1], where e represents the residual error between the target x and the encoder output ε(y), and ∈˜ [symbol] (0,1) is the noise. This forward process facilitates the construction of a backward process, where a velocity field v(xₜ;t) can be learned by minimizing the flow matching loss in

$${min}_{θ} {𝔼}_{t , {x}_{t}} [ {‖ v ( {x}_{t} ; t ) - ( {x}_{1} - {x}_{0} ) ‖}^{2} ] ,$$

where xₜ=(1−t)x₀+tx₁, and the ground truth velocity is vₜᵣᵤₑ(xₜ;t)=x₁−x₀. At each iteration, x₀ and x₁ represent input and output, respectively, of the AFM network 240. Once the velocity field is learned, the forward integration process from t=0 to t=1 can be expressed as:

$$x = {\int }_{t = 0}^{t = 1} {v}_{θ} ( {x}_{t} , t ) dt . \qquad ( Eq . 6 )$$

In at least one embodiment, the denoising process at each iteration involves predicting the noise added to a future state (e.g., the next iteration of the latent variable) to reach the current state (e.g., the current iteration of the latent variable) and then subtracting the predicted noise to obtain the denoised version.

Table 1 illustrates an algorithm (denoted as Algorithm 1) for training the framework, in accordance with certain embodiments.

TABLE 1
Algorithm 1 for training

$1 : Input : λ , {\{ ( {y}_{i} , {x}_{i} ) \}}_{i = 1}^{N}$
2: Initialize σ_{z}, θ, ε
3: repeat
4: Sample σₜ~ [symbol] [0, σ_{z}] and ϵ~ [symbol] (0, I)
5: Computer error: e := (ε(y) − x)/σ_{z}
6: Perturb input: xₜ = x + σₜ (e − ϵ)
7: Take a gradient step on:
$8 : {∇}_{θ , ℰ} [ {( \frac{{σ}_{z}}{{σ}_{t}} )}^{2} {‖ {𝒟}_{θ} ( {x}_{t} , {σ}_{t} ) - x ‖}^{2} + λ {‖ e ‖}^{2} ]$
9: until convergence

In at least one embodiment, at stage 342, the noise parameter (or parameter vector) σ_{z} is updated during the training, for example, using at least one validation set periodically throughout the training process. As shown in FIGS. 1D and 1E, a noise parameter σ_{z} can be output from the training.

At stage 350, a trained framework is output from the training process. In at least one embodiment, the trained framework is obtained when the model has converged.

Table 2 illustrates an algorithm (denoted as Algorithm 2) for using the framework during inference, in accordance with certain embodiments.

TABLE 2
Algorithm 2 for inference/sampling

| | |
|---|---|
| 1: | Input: y, Δt, σ_{z}, [symbol] _{θ}, ε |
| 2: | Sample noise ∈ ~ [symbol] (0, I) |
| 3: | Form latent z = ε(y) + σ_{z}∈ |
| 4: | Initialize x₀ = z |
| 5: | for t = 0 : Δt : 1 do |
| 6: | σₜ = (1 − t)σ_{z} |
| 7: | ν_{θ}(xₜ,t) = ( [symbol] _{θ}(xₜ,σₜ) − xₜ)/(1 − t) |
| 8: | x_{t+Δt} = xₜ + ν_{θ} (xₜ, t) · Δt |
| 9: | end for |
| 10: | return x₁ |

As shown in Algorithm 2, an initial input (x₀=z) to the denoising neural network ( [symbol] ) is formed based on the output from the encoder (ε) and a noise perturbation (o_{z}∈). At each iteration, the denoising neural network ( [symbol] ) predicts a less noised version of the input latent to compute a velocity field (v(xₜ,t)). The computed velocity field v(xₜ;t) is used to compute the noise, which is subtracted from the input latent to calculate an updated latent (x_{t=Δt}) at each iteration. After a number of iterations, the AFM network 240 outputs a final result (x=x₁).

In at least one embodiment, the training dataset includes input and ground truth data for varying levels of misalignment (e.g., τ=3, 5, 10). As t increases, the discrepancy between the coarse and fine-resolution fields grows, offering a controlled environment to test atmospheric super-resolution (i.e., downscaling) performance.

The framework 200 consistently outperforms other methods across various skill metrics for different degrees of misalignment. FIG. 3B illustrates a comparison of model performance when the level of misalignment is set to τ=10. Data map 360a is a coarse-resolution input from the training dataset, while data map 362a is a corresponding fine-resolution ground truth from the training dataset. Data maps 364a-368a depict predicted target outputs generated by the first, second, and third models (e.g., U-Net, Conditional Flow Matching (CFM), Conditional Diffusion Model (CDM), respectively), and are compared to data map 370a, which is generated by framework 200. Data maps 360b-370b provide zoomed-in views of selected regions from the corresponding data maps 360a-370a. As shown in FIG. 3B, the output from framework 200 (e.g., data maps 370a and 370b) exhibit a closer alignment with the ground truth (e.g., data maps 362a and 362b). Moreover, the outputs generated by framework 200 exhibit fewer high-frequency artifacts compared to those of the other models.

FIG. 3C illustrates examples of outputs from various models, in accordance with certain embodiments. From top to bottom, the first row displays data maps for maximum radar reflectivity, the second row for temperature, the third row for castward wind, and the fourth row for northward wind. From left to right, the first column contains input data (if available), the second through fifth columns present outputs from various models (e.g., U-Net, CFM, CDM, Corrective Diffusion Model (CorrDiff), respectively) for comparison, the sixth column displays outputs from framework 200, and the seventh column provides ground truth outputs. In this example, the framework 200 uses adaptive flow matching (AFM), incorporates a U-Net architecture, and sets the penalty weight (1) to zero. The outputs are displayed in spectra.

Spectral analysis is used for assessing fidelity at different scales in weather prediction. As shown in FIG. 3C, the spectra produced by framework 200 closely match the ground truth across variables. In contrast, the U-Net-based regression scheme fails to generate high-frequency components. The conditional diffusion model (CDM), commonly used for image super-resolution, also lacks spectral fidelity.

Performance can be evaluated using various metrics, such as RMSE, Continuous Ranked Probability Score (CRPS), Mean Absolute Error (MAE), and Spread Skill Ratio (SSR). These metrics provide a comprehensive assessment of both the accuracy and uncertainty quantification of the model's predictions. RMSE, CRPS, and MAE measure estimation error, while SSR assesses model calibration.

In terms of ensemble calibration (e.g., SSR), the framework 200 achieves the best balance, being closest to 1.0. While framework 200 does not fully resolve the general problem of under-dispersive super-resolution, it does improve the balance between the spread and RMSE skill of the generated ensemble, particularly for surface wind channels.

Additionally, experimental results demonstrate that the framework 200 consistently outperforms other models across various metrics for non-deterministic channels (e.g., radar and wind). For temperature prediction, increasing the penalty weight (1) allows Framework 200 to achieve performance comparable to CorrDiff. However, this comes at the expense of reduced stochasticity in predictions for non-deterministic channels.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

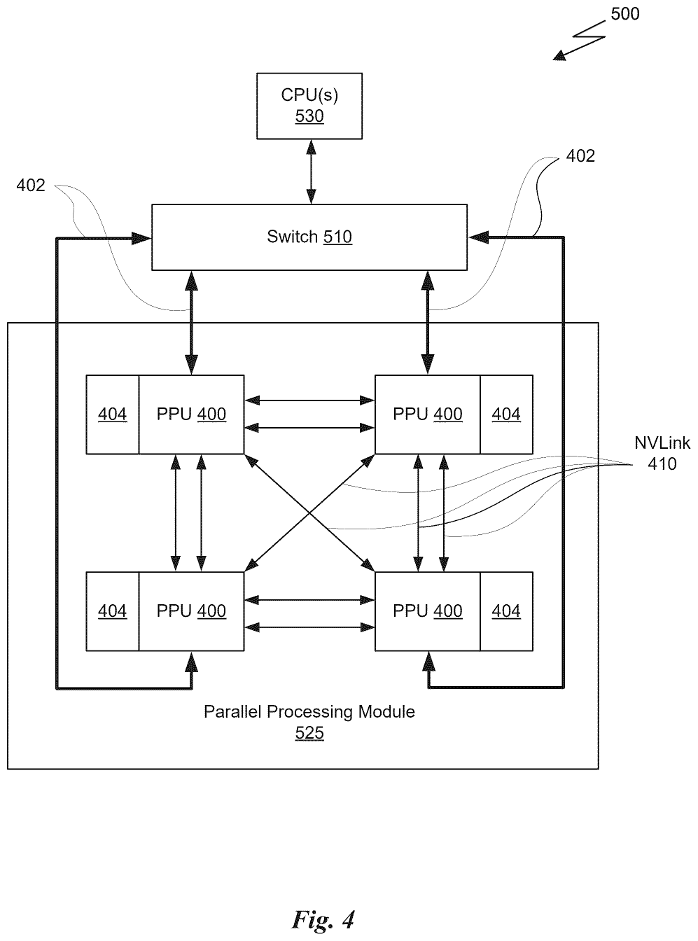

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMS), Trec Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

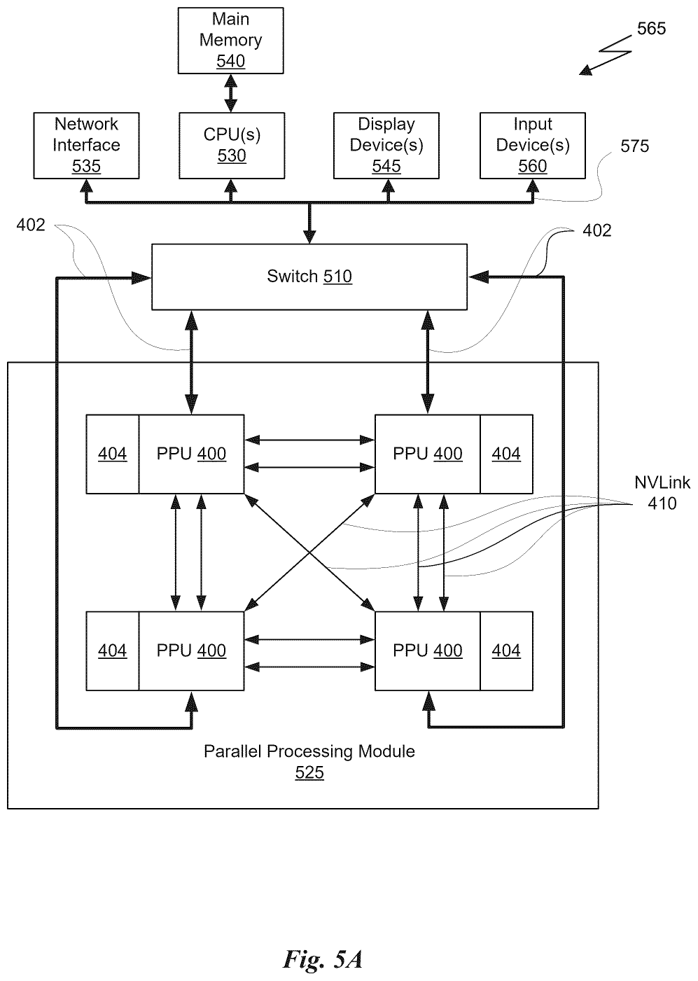

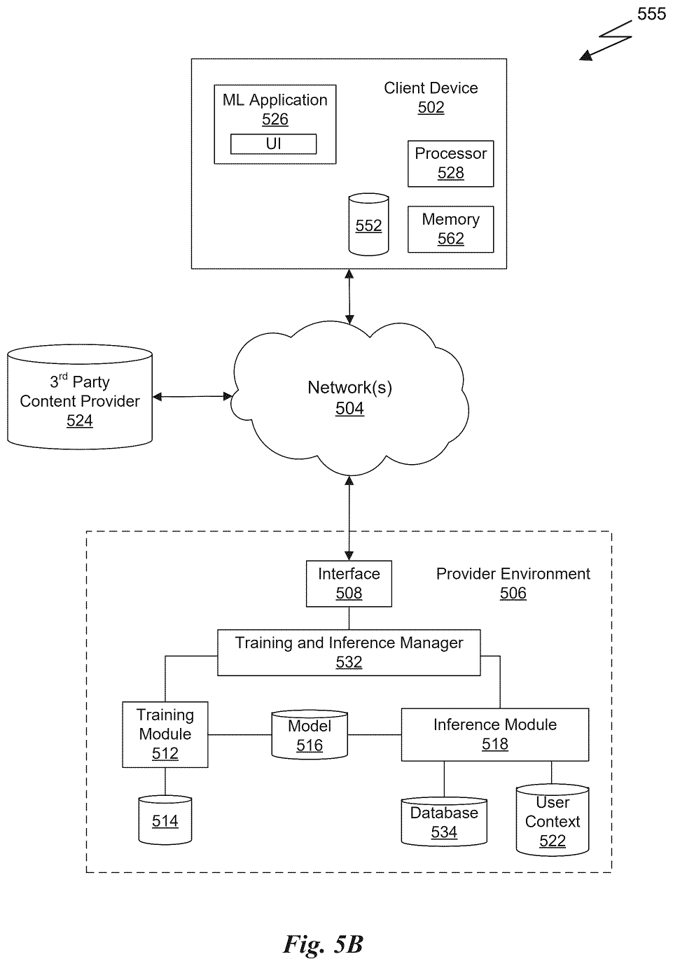

FIG. 5A illustrates an exemplary system 565 in which the various architecture and/or functionality of the various previous embodiments may be implemented. The exemplary system 565 may be configured to implement the method 100 shown in FIG. 1A and/or the method 300 shown in FIG. 3A.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

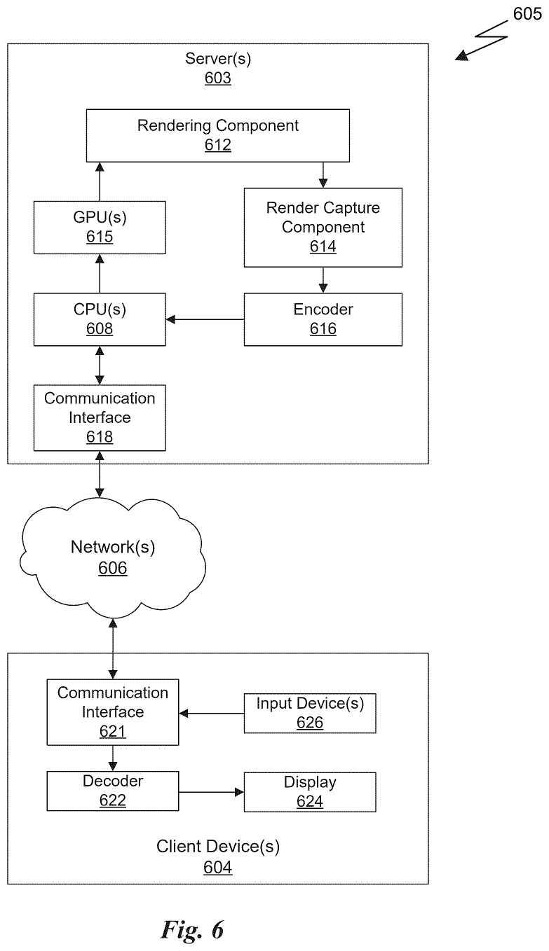

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for adaptive flow matching, comprising:
receiving input comprising one or more first variables at a first scale;
encoding, using an encoder, the input to provide a base distribution at the first scale, wherein the base distribution is associated with one or more second variables, and the one or more second variables include one or more variables absent from the one or more first variables;
obtaining, based on the base distribution and an adaptive noise, a perturbed base distribution; and
generating, by a diffusion model, a target distribution at a second scale, wherein the target distribution is associated with the one or more second variables, and wherein the second scale is finer than the first scale.

2. The method of claim 1, wherein the adaptive noise is determined based on a noise parameter, wherein the noise parameter is determined based on evaluating errors from the encoding process.

3. The method of claim 2, wherein the noise parameter is dynamically updated by calculating a root-mean-square-error (RMSE) of a residual error, the residual error is determined based on a difference between the output from the encoder and the output from the diffusion model.

4. The method of claim 2, wherein the noise parameter is a vector comprising one or more elements, wherein each of the one or more elements in the noise parameter corresponds to a second variable among the one or more second variables.

5. The method of claim 1, wherein the encoder and the diffusion model are trained jointly.

6. The method of claim 1, wherein the base distribution and the target distribution are processed in latent space.

7. The method of claim 1, wherein the diffusion model receives the perturbed base distribution as an initial input, and wherein the diffusion model generates features at the second scale over multiple iterations.

8. The method of claim 7, wherein the diffusion model comprises a denoising network, wherein the method further comprises:
receiving, by the denoising network at each iteration, output from the previous iteration as input to obtain a velocity field; and
generating, by the denoising network, the output for the respective iteration by adding an amount of features based on the velocity field.

9. The method of claim 1, wherein the input and output comprise weather data, and wherein the one or more first variables and the one or more second variables comprise weather variables.

10. A system for adaptive flow matching comprising:
one or more processors to:
receive input comprising one or more first variables at a first scale;
encode, using an encoder, the input to provide a base distribution at the first scale, wherein the base distribution is associated with one or more second variables, and the one or more second variables include one or more variables absent from the one or more first variables;
obtain, based on the base distribution and an adaptive noise, a perturbed base distribution; and
generate, by a diffusion model, a target distribution at a second scale, wherein the target distribution is associated with the one or more second variables, and wherein the second scale is finer than the first scale.

11. The system of claim 10, wherein the adaptive noise is determined based on a noise parameter, wherein the noise parameter is determined based on evaluating errors from the encoding process.

12. The system of claim 11, wherein the noise parameter is dynamically updated by calculating a root-mean-square-error (RMSE) of a residual error, the residual error is determined based on a difference between the output from the encoder and the output from the diffusion model.

13. The system of claim 11, wherein the noise parameter is a vector comprising one or more elements, wherein each of the one or more elements in the noise parameter corresponds to a second variable among the one or more second variables.

14. The system of claim 10, wherein the encoder and the diffusion model are trained jointly.

15. The system of claim 10, wherein the base distribution and the target distribution are processed in latent space.

16. The system of claim 10, wherein the diffusion model receives the perturbed base distribution as an initial input, and wherein the diffusion model generates features at the second scale over multiple iterations.

17. The system of claim 16, wherein the diffusion model comprises a denoising network, wherein the one or more processors further perform:
receiving, by the denoising network at each iteration, output from the previous iteration as input to obtain a velocity field; and
generating, by the denoising network, the output for the respective iteration by adding an amount of features based on the velocity field.

18. The system of claim 10, wherein the input and output comprise weather data, and wherein the one or more first variables and the one or more second variables comprise weather variables.

19. A non-transitory computer-readable media storing computer instructions for adaptive flow matching that, when executed by one or more processors, cause the one or more processors to perform the steps of:
receiving input comprising one or more first variables at a first scale;
encoding, using an encoder, the input to provide a base distribution at the first scale, wherein the base distribution is associated with one or more second variables, and the one or more second variables include one or more variables absent from the one or more first variables;
obtaining, based on the base distribution and an adaptive noise, a perturbed base distribution; and
generating, by a diffusion model, a target distribution at a second scale, wherein the target distribution is associated with the one or more second variables, and wherein the second scale is finer than the first scale.

20. The non-transitory computer-readable media of claim 19, wherein the adaptive noise is determined based on a noise parameter, wherein the noise parameter is determined based on evaluating errors from the encoding process.
